(19) United States
(12) Patent Application Publication
(10) Pub. No.: US 2002/0090018 A1
(43) Pub. Date: Jul. 11, 2002

(54) Multi-positional aluminum melting furnace and method for operating same

(76) Inventors: William A. Zebedee, Rancho Santa Fe, CA (US); Han Spoel, Toronto (CA)

Correspondence Address: HARNESS, DICKEY & PIERCE, P.L.C., P.O. BOX 828, BLOOMFIELD HILLS, MI, 48303, US

(21) Appl. No.: 10/028,755

(22) Filed: Dec. 20, 2001

Related U.S. Application Data
(60) Provisional application No. 60/257,688, filed on Dec. 21, 2000.

(51) Int. Cl. F27D 1/00; F27D 3/14

(52) U.S. Cl. 373/71; 373/20; 373/84

(57) ABSTRACT

A tiltable rotary furnace system includes a tiltable rotary furnace which rotates about a central axis and pivots around a general horizontal axis similar to a typical tiltable rotary furnace. The tiltable rotary furnace and the rotating and pivoting mechanisms are mounted on a rotating platform. The rotating platform allows the furnace to be positioned with respect to other elements of the system rather than having to position the other elements of the system with respect to a stationary tiltable rotary furnace.

### CROSS-REFERENCE TO RELATED APPLICATIONS

This application claims the benefit of U.S. Provisional Application No. 60/257,688, filed Dec. 21, 2000.

### FIELD OF THE INVENTION

The present invention relates to a tiltable rotary furnace. More particularly, the present invention relates to a tiltable rotary furnace which is able to pivot or slew between a plurality of positions.

### BACKGROUND OF THE INVENTION

Tiltable rotary furnaces are in widespread use in the secondary aluminum industry, and particularly for processors of dross. The shell of the tiltable rotary furnace is an annular bottle-shaped container which is open at one end. The shell is mounted to a fixed base such that the shell rotates around a central axis and that it tilts to raise the bottom of the shell in order to discharge the metal and the residues.

The tiltable rotary furnace is charged typically with a forklift or some form of feeding system that is positioned in front of the open end or mouth of the shell. The forklift or feeding system fills the shell of the tiltable rotary furnace and it is then pulled or moved out of the way. Once the forklift or feeding system is clear of the tiltable rotary furnace, a burner is swung into place. The burner can be mounted in a door of the furnace or it can simply consist of a gas pipe which is inserted into the mouth of the furnace and then ignited. When the charge or heat is “cooked”, the burner is swung away or removed from the furnace and either a crucible or an ingot mold is moved into position to receive the metal being poured. Some designs for the tiltable rotary furnaces include a “lazy Susan” approach to positioning crucibles or ingot molds in order to avoid the problems of having to move each mold individually both before and after the pouring. In the systems that individually move each crucible or ingot mold, a forklift truck is typically used to properly position each crucible or ingot mold.

Once all of the metal has been poured, a salt cake pan is positioned under the mouth of the tiltable rotary furnace to receive the residue, called saltcake in the industry. Typically, several salt cake pans are required, which means that the pouring process for the saltcake must be interrupted, similar to the metal pouring process, as each pan is filled, removed and another empty pan is put in its place.

While the tiltable rotary furnaces in use today provide acceptable results, there is a need to improve the overall process or system in order to reduce manpower required to operate the tiltable rotary furnace and increase the productivity of the tiltable rotary furnace. Currently, in each step of the process, a device such as the loading system, the burner, the ingot molds or crucibles and the saltcake pans must first be positioned with respect to the tiltable rotary furnace and then removed prior to the beginning of the next step of the process. Various techniques have been developed for “swinging” the various devices in from the sides, but these swinging devices add significantly to the overall cost of the system. Also, since there are only effectively two sides and possibly the top of the tiltable rotary furnace for access and there are essentially four devices which must be positioned with respect to the tiltable rotary furnace, these swinging devices are limited in their applicability.

Accordingly, what is needed is a system which is capable of properly positioning each of the various devices with respect to the tiltable rotary furnace in such a way that movement of the various devices is reduced, simplified or eliminated. In this manner, the productivity of the tiltable rotary furnace can be significantly improved.

### SUMMARY OF THE INVENTION

The present invention provides the art with a tiltable rotary furnace that is rotatable about a central axis, is pivotally mounted in order to raise the bottom of the furnace in order to discharge the metal and residue and the entire system can be pivoted or “slewed” about a generally vertical axis in order to have the furnace move to the devices rather than having the devices move to the furnace. In this manner, each of the needed devices such as the charging or feeding system, the burner, the ingot molds or the crucible and the saltcake pans can all be circumferentially located around the tiltable rotary furnace and the furnace can slew to each of the appropriate devices when necessary.

Other advantages and objects of the present invention will become apparent to those skilled in the art from the subsequent detailed description, appended claims and drawings.

### BRIEF DESCRIPTION OF THE DRAWINGS

In the drawings which illustrate the best mode presently contemplated for carrying out the present invention:

FIG. 1 is a schematic plan view of the tiltable rotary furnace system in accordance with the present invention; and

FIG. 2 is a schematic side view of the tiltable rotary furnace shown in FIG. 1.

### DETAILED DESCRIPTION OF THE PREFERRED EMBODIMENT

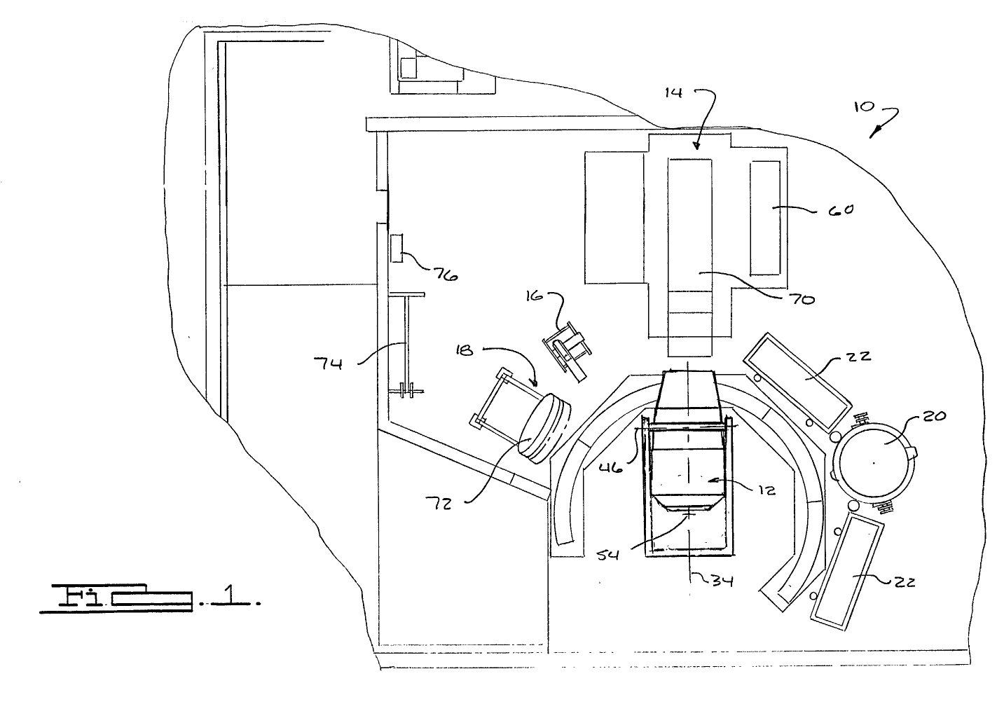

Referring now to the drawings in which like reference numerals designate like or corresponding parts throughout the several views, there is shown in FIG. 1 a tiltable rotary furnace system in accordance with the present invention which is designated generally by the reference numeral 10. Tiltable rotary furnace system 10 includes a tiltable rotary furnace 12, a feeding system 14, a purge blower 16, a burner assembly 18, a crucible 20 and a plurality of saltcake pans 22. While tiltable rotary furnace system 10 is illustrated having crucible 20, it is within the scope of the present invention to utilize one or more ingot molds in place of crucible 20 if desired.

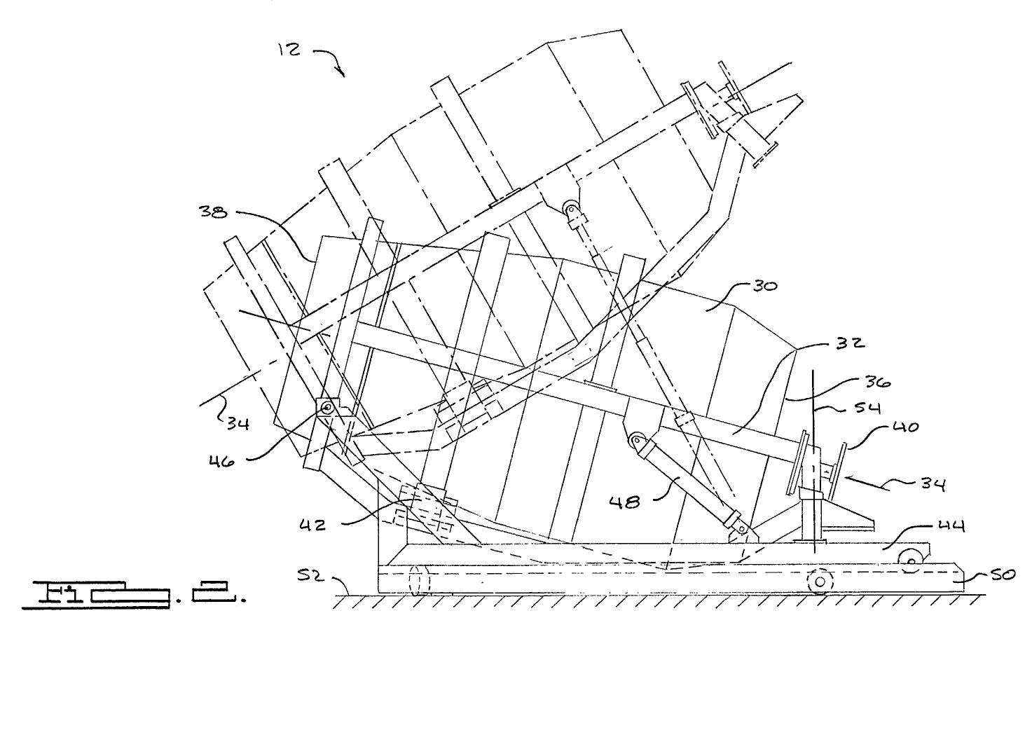

Referring now to FIG. 2, tiltable rotary furnace 12 comprises a furnace shell 30 which is rotatably supported by a frame 32 such that furnace shell 30 is rotatable around a central axis 34. Furnace shell 30 has a closed end 36 and an open end 38. Frame 32 includes a drive system 40 attached to closed end 36 of furnace shell 30 for rotating furnace shell 30 about axis 34 and a pair of rollers 42 which support furnace shell 30 for its rotation about axis 34.

A base assembly 44 pivotably supports frame 32 and furnace shell 30 such that frame 32 and furnace shell 30 can pivot around a general horizontal axis 46 as shown in phantom in FIG. 2. Axis 46 is located adjacent open end 38 of furnace shell 30 in order to allow for the tilting of furnace shell 30 in order to pour the metal and residue from open end 38 as detailed below. A lifting system in the form of a pair of hydraulic cylinders 48 are disposed on opposite sides of frame 32 between base assembly 44 and frame 32 to effect the pivoting of frame 32 and furnace shell 30.

A platform 50 supports base assembly 44. Platform 50 is rotatably supported with respect to a floor 52 of a plant such that it can slew about a generally vertical axis 54. The slewing of platform 50 and thus base assembly 44, frame 32 and furnace shell 30 can be controlled manually or it can be controlled by a microprocessor in order to be positioned at each station as detailed below.

Referring back to FIG. 1, the process utilizing tiltable rotary furnace system 10 will be described. The initial step in the process is to charge furnace shell 30 with the appropriate amount of material. Platform 50 is slewed about axis 54 until open end 38 of furnace shell 30 is positioned in front of or adjacent feeding system 14. Feeding system 14 preferably comprises an inverter 60 or front end loader to load a vibratory feeder 70. Once open end 38 of furnace shell 30 is positioned adjacent vibratory feeder 70 of feeding system 14, feeding system 14 is activated to fill furnace shell 30 with the appropriate amount of material. The activation of feeding system 14 moves vibratory feeder 70 generally horizontal such that it extends into open end 38 of furnace shell 30. Once furnace shell 30 has been filled, feeding system 14 is deactivated which retracts vibratory feeder 70 and platform 50 is slewed about axis 54 to position furnace shell 30 adjacent purge blower 16.

Optionally, once furnace shell 30 is disposed adjacent purge blower 16, purge blower 16 is activated to blow air into furnace shell 30 to clear any gas contaminants. Once furnace shell 30 has been purged, platform 50 is slewed about axis 54 to position furnace shell 30 adjacent burner assembly 18.

Burner assembly 18 preferably comprises a longitudinally movable burner 72, an oxy-fuel skid 74 and a control panel 76. While burner assembly 18 is being illustrated as having oxy-fuel skid 74 and control panel 76, other means known in the art for firing burning 72 can be used in place of skid 74 and panel 76, if desired. Platform 50 is slewed about axis 54 until open end 38 of furnace shell 30 is positioned adjacent pivotal burner 72. Burner 72 is moved longitudinally to cover open end 38 and once properly positioned, burner 72 is ignited to melt the material within furnace shell 30. When the material is properly melted or “cooked”, burner 72 is turned off and burner 72 is moved longitudinally away from open end 38 of furnace shell 30. The longitudinal movement of burner 72 instead of the pivotal movement of typical burners allows for reducing the distance that burner 72 must move. Typically burner 72 only needs to be moved approximately one foot in order to avoid the slewing movement of furnace shell 30. Platform 50 is then slewed about axis 54 to position furnace shell 30 adjacent crucible 20.

Once furnace shell 30 is positioned adjacent crucible 20, hydraulic actuators 48 are actuated to pivot furnace shell 30 about axis 46. The pivoting of furnace shell 30 about axis 46 raises closed end 36 of furnace shell 30 above the level of open end 38 of furnace shell 30 causing the liquid metal within furnace shell 30 to be poured from furnace shell 30 into crucible 20 as shown in phantom in FIG. 2. Once the supply of liquid metal has been dispensed from furnace shell 30, hydraulic actuators 48 are deactivated which causes furnace shell 30 to pivot about axis 46 back to its original position. While tiltable rotary furnace system 10 is illustrated as having one crucible 20, it is within the scope of the present invention to have multiple crucibles 20 or to have one or more ingot molds in place of crucible 20. If multiple crucibles 20 or ingot molds are utilized, hydraulic actuators 48 are deactivated after filling each crucible 20 or ingot mold and platform 50 is then slewed about axis 54 to be adjacent the next empty crucible 20 or the ingot mold. At this time, hydraulic actuators 48 are activated again to fill the empty crucible 20 or the ingot mold. This process is continuously repeated until the supply of liquid metal within furnace shell 30 is exhausted. Once the supply of liquid metal within furnace shell 30 is exhausted, platform 50 is slewed about axis 54 to position furnace shell 30 adjacent one of the plurality of saltcake pans 22.

After pouring the liquid metal from furnace shell 30, the residue within furnace shell 30 must be emptied. When furnace shell 30 is positioned adjacent one of the plurality of saltcake pans 22, hydraulic actuators 48 are activated to pivot furnace shell 30 about axis 46. The pivoting of furnace shell 30 about axis 46 raises closed end 36 of furnace shell 30 above the level of open end 38 of furnace shell 30 causing the residue within furnace shell 30 to be poured into the first saltcake pan 22. When the first saltcake pan 22 is filled, hydraulic actuators 48 are deactivated which causes furnace shell 30 to pivot about axis 46 back to its original position. Platform 50 is slewed about axis 54 to position furnace shell 30 adjacent the second saltcake pan 22. Hydraulic actuators 48 are again activated and the residue within furnace shell 30 is poured into the second saltcake pan 22. When the second saltcake pan 22 is filled, hydraulic actuators 48 are deactivated to return furnace shell 30 to its original position. This process continues until all of the residue within furnace shell 30 has been poured into saltcake pans 22.

During the various steps of the process described above, drive system 40 rotates furnace shell 30 about axis 34 when necessary.

Tiltable rotary furnace system 10 thus provides a unique system and method for operating a tiltable rotary furnace when processing dross and preferably when processing hot dross. By positioning the tiltable rotary furnace with respect to the required devices rather than the devices with respect to the tiltable rotary furnaces, tiltable rotary furnace system 10 operates more efficiently increasing the productivity of the system.

While the above detailed description describes the preferred embodiment of the present invention, it should be understood that the present invention is susceptible to modification, variation and alteration without deviating from the scope and fair meaning of the subjoined claims.

What is claimed is:

1. A tiltable rotary furnace system comprising:
a tiltable rotary furnace;
a frame rotatably supporting said tiltable rotary furnace;
a base assembly pivotably supporting said frame; and
a platform supporting said base assembly, said platform being adapted to rotate with respect to a floor.

2. A method of operating a tiltable rotary furnace, the method comprising:
positioning said tiltable rotary furnace at a first location;
charging said tiltable rotary furnace; and
rotating said tiltable rotary furnace to a second location.
